(19) United States
(12) Patent Application Publication
(10) Pub. No.: US 2007/0243445 A1
(43) Pub. Date: Oct. 18, 2007

(54) High power density seal-less tubular solid oxide fuel cell by means of a wide interconnection

(75) Inventor: Gianfranco Digiuseppe, Grand Blanc, MI (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/403,636

(22) Filed: Apr. 13, 2006

(51) Int. Cl. H01M 8/12; H01M 4/90

(52) U.S. Cl. 429/31; 429/40

(57) ABSTRACT

The present invention is a solid oxide fuel cell that includes at least one flat support tube having a first side, a second side, and an outer surface and at least one interconnection (3) deposited to the full surface of the outer surface of at least one side of the tube. At least one support tube comprises a solid electrolyte layer (4) that is deposited over an outer surface of the support tube. At least a portion of the interconnect is covered with electrolyte and at least one anode (5) is applied over the electrolyte.

The U.S. Government has a paid-up license in this invention and the right in limited circumstances to require the patent owner to license others on reasonable terms as provided for by the terms of DE-FC26-02NT41247 awarded by DOE.

### FIELD OF THE INVENTION

The field of the invention relates generally to fuel cells, and more specifically to the shape and structure of solid oxide fuel cells.

### BACKGROUND

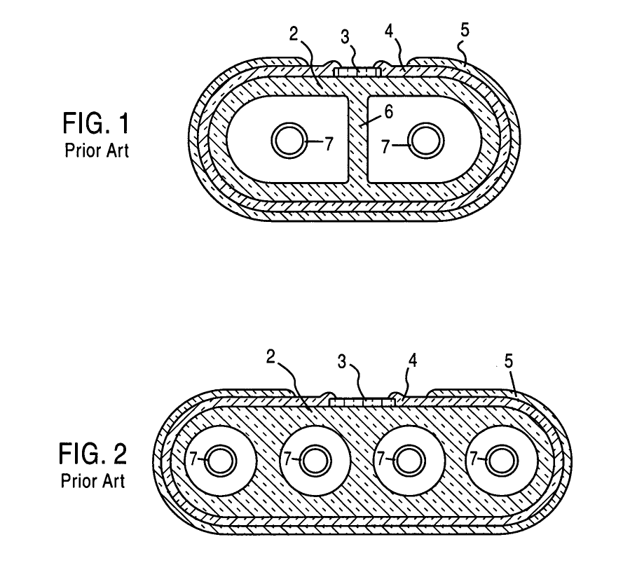

An example of a typical solid oxide fuel cell with conductive ribs at the cathode side is shown in FIGS. 1 and 2. These types of solid oxide fuel cells are known in the art. The primary parts of the fuel cell are the support tube, which acts as a porous substrate only or can be made of the same material as the cathode 2 to provide an electronic media as well as porosity. Extra conductive paths can be introduced in the form of ribs 6. The number of ribs 6 will depend on the desired power output.

The interconnection 3 provides electronic contact to the next cell in the series. A solid electrolyte 4 is then deposited over the tubes substrate and a small portion of the interconnection. The interconnection and electrolyte provide leak tightness and prevent the fuel to mix with the air. An anode 5 is applied over the solid electrolyte, which provides the cell active electrochemical area. An air feed tube 7 is also included so that the air or the oxidant can be introduced to the cathode 2.

Designs may be cylindrical or flattened tubes, and comprise open or closed ended, axially elongated, ceramic tube air electrode material covered by thin film solid electrolyte and interconnection material. The electrolyte layer is covered by cermet fuel electrode material, except for a thin, axially elongated interconnection material. The flat type fuel cells comprise a flat array of electrolyte and interconnect walls or ribs, where electrolyte walls contain thin, flat layers of cathode and anode materials sandwiching an electrolyte.

While the known fuel cells are effective the lack of good electrical contact area on the full surface of the side of the tube results in a weaker output power per cell than desired. Other embodiments of the present invention also exist, which will be apparent upon further reading of the detailed description.

### SUMMARY OF THE INVENTION

With the foregoing in mind, methods and apparatuses consistent with the present invention, which inter alia facilitates the need for greater output per cell that includes at least one flat support tube having a first and a second side, and an outer surface. The cell comprises at least one interconnection 3 that is connected to the full surface of the outer surface of one side of the tube. The support tube comprises a solid electrolyte layer that is deposited over an outer surface of the support tube. The electrolyte also covers a portion of the interconnection layer. And, at least one anode is applied over most of the electrolyte layer.

In another embodiment, the invention is a solid oxide fuel cell that includes at least one flat support tube having a first side, a second side, and an outer surface; at least one interconnection electrically connected to the next cell in series; ribs adapted to conduct electricity about the outer surface of the support tube and an air feed tube adapted to introduce an oxidant to the support tube. The support tube comprises a solid electrolyte layer that is deposited over an outer surface of the support tube and wherein at least one anode is applied over the electrolyte. In particular embodiments at least a portion of the interconnect comprises nickel masking material about its surface.

In yet another embodiment of the invention the solid oxide fuel cell includes at least one flat support tube having a first side, a second side, and an outer surface and at least one interconnection electrically connected to at least a majority of the surface of the outer surface of at least one side of the tube. The support tube comprises a solid electrolyte layer that is deposited over an outer surface of the support tube.

These and other objects, features, and advantages in accordance with the present invention are provided particular embodiments by the solid oxide fuel cell of the invention. Other embodiments of the present invention also exist, which will be apparent upon further reading of the detailed description.

### BRIEF DESCRIPTION OF THE FIGS.

The invention is explained in more detail by way of example with reference to the following drawings:

FIGS. 1 and 2 illustrate a known flat fuel oxide cell; and

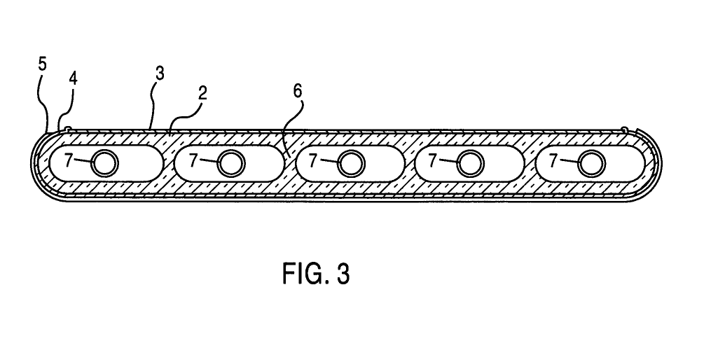

FIG. 3 illustrates one embodiment of the flat fuel cell of the invention.

### DETAILED DESCRIPTION OF THE INVENTION

The present invention provides for a fuel cell design that comprises at least one flat support tube having at least two sides and an outer surface. With reference to FIG. 3, a solid oxide fuel cell is illustrated that includes at least one flat support tube having a first and a second side, and an outer surface. The cell comprises at least one interconnection 3 that is deposited to the full surface of the outer surface of at least one side of the tube. The support tube comprises a solid electrolyte layer 4 that is deposited over an outer surface of the support tube. At least a portion of the interconnect is also covered with electrolyte material. At least one anode 5 is applied over the electrolyte.

In the prior art, fuel cells employed very narrow interconnections that covered only a small portion of the outer surface of the fuel cell. By having an interconnection 3 that covers more surface area of the outer surface of one side of the tube, optimal current distribution is achieved. In accordance with the invention, optimal current distribution is achieved by applying at least one interconnection 3 to at least a majority of one side so that the flat surface is completely covered up to the beginning of the curvature of each side. As used herein the term “majority” means at least 51 percent. In other words, the interconnect covers at least 51 percent of the outer surface area of one side of the support tube. “One side” refers to a flat portion of the tube and does not include the approximate area where curvature begins. This tends to equalize the current path length so that each rib 6 would have nearly equivalent resistances. In doing so, the sides of the cell can be also considered ribs 6 as the cell has no inactivity, that is the current is flowing through all the active surface area. This increases cell performance by enhancing the electrochemical reactions at the fuel cell electrochemically active interfaces. In particular embodiments the interconnect covers up to the full outer flat surface of one side of the cell.

At least one support cathode tube 2 comprises a solid electrolyte layer 4 that is deposited over an outer surface of the support tube. At least a portion of the interconnect 3 is covered with electrolyte material. At least one anode 5 is applied over the electrolyte.

This invention provides an important distinction over previous solid oxide fuel cell designs. The design provides an optimal current distribution, which enhances the power output. In accordance with the invention the interconnect is applied on one side so a majority of the outer surface of the support tube is covered by the interconnect. This results in optimal current distribution. The current path length is equalized so that each rib 6 has nearly equivalent resistances. In doing so, the sides of the cell can be also considered ribs 6 as the cell has no inactivity. Therefore the current is optimally flowing through all the active surface area. This enhances the electrochemical reactions at the fuel cell interfaces. Previous designs allow each side to act as resistor of greater resistances, allowing the current to flow toward the path of lowest resistance and reduce the active electrochemical area.

In a specific embodiment of the invention, the interconnect completely covers at least one side of the outer surface of the support tube. The support tube of the invention is of variable length and can act as a porous substrate only or can be made of the same material as the corresponding cathode 2 to provide an electronic media as well as porosity. The tubes may be any applicable support tube known in the art, including but not limited to flat tubes. The number of ribs 6 is dependent upon the power output. Anyone skilled in the art could determine the number of ribs to introduce without undue experimentation.

In accordance with the invention, the cell wall thickness will not exceed values where pore diffusion is comprised and cell performance is lowered. The rib 6 to wall interfaces will have a radius, and the closed end with be ellipsoidal in nature.

In another embodiment the present invention includes at least one flat support tube having a first and a second side, and an outer surface. The cell comprises at least one interconnection 3 that is connected to the full surface of the outer surface of at least one side of the tube. The support tube comprises a solid electrolyte layer that is deposited over an outer surface of the support tube. At least a portion of the interconnect is covered with electrolyte material, and at least one anode is applied over the electrolyte.

In another embodiment, the invention is a solid oxide fuel cell that includes at least one flat support tube having a first side, a second side, and an outer surface; at least one interconnection electrically connected to the full surface of the outer surface of at least one side of the tube; ribs adapted to conduct electricity about the outer surface of the support tube and an air feed tube are adapted to introduce an oxidant to the support tube. The support tube comprises a solid electrolyte layer that is deposited over an outer surface of the support tube and wherein at least one anode is applied over the electrolyte.

In yet another embodiment of the invention the solid oxide fuel cell includes at least one flat support tube having a first side, a second side, and an outer surface and at least one interconnection deposited to at least a majority of the surface of the outer surface of at least one side of the tube. The support tube comprises a solid electrolyte layer that is deposited over an outer surface of the support tube. At least one anode is applied over the electrolyte.

The anode 5 is applied over the solid electrolyte. The anode 5 provides the cell active electrochemical area. Usually cylindrical cells are connected into bundles by means of an electrical connection made of nickel felts, screen, or screen and felt combinations. In one embodiment of the invention air or the oxidant is introduced to the cathode by means of an air feed tube.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and, any and all equivalents thereof.

What is claimed is:

1. A solid oxide fuel cell comprising:
at least one flat support tube having a first side, a second side, and an outer surface; and
at least one interconnection electrically deposited to the full surface of the outer surface of one side of the tube;
wherein the at least one support tube comprises a solid electrolyte layer that is deposited over an outer surface of the support tube;
wherein at least one anode is applied over the electrolyte.

2. The fuel cell of claim 1 wherein an oxidant is introduced to the support tube by an air feed tube.

3. The fuel cell of claim 1 wherein the anode is made of at least one of Ni felts, Ni screen and combinations thereof.

4. The fuel cell of claim 1 wherein the masking material is a metal.

5. The fuel cell of claim 1 wherein the masking material is nickel.

6. The fuel cell of claim 1 further comprising ribs adapted to conduct electricity.

7. A solid oxide fuel cell comprising:
at least one flat support tube having a first side, a second side, and an outer surface;
ribs adapted to conduct electricity; and
at least one interconnection deposited to at least a majority of the surface of the outer surface of one side of the tube;
wherein the at least one support tube comprises a solid electrolyte layer that is deposited over an outer surface of the support tube; and
wherein at least one anode is applied over the electrolyte.

8. The fuel cell of claim 6 further comprising a means for introducing an oxidant to the support tube.

9. The fuel cell of claim 8 wherein the means for introducing an oxidant to the support tube is an air feed tube.

10. The fuel cell of claim 7 wherein the anode is made of Ni felts, Ni screen or Ni screen and Ni foam combination.

11. The fuel cell of claim 7 wherein the masking material is a metal.

12. The fuel cell of claim 7 wherein the masking material is nickel.

13. A solid oxide fuel cell comprising:
at least one flat support tube having a first side, a second side, and an outer surface;
at least one interconnection deposited to at least a majority of the surface of the outer surface of one side of the tube;
ribs adapted to conduct electricity about the outer surface of the support tube;
an air feed tube adapted to introduce an oxidant to the support tube;
wherein the at least one support tube comprises a solid electrolyte layer that is deposited over an outer surface of the support tube; and
wherein at least one anode is applied over the electrolyte.

14. The fuel cell of claim 13 wherein the anode is made at least one of Ni felts, Ni screen and combinations thereof.
